(19) United States
(12) Patent Application Publication
(10) Pub. No.: US 2006/0127539 A1
(43) Pub. Date: Jun. 15, 2006

(54) Food package and method for heating a food package

(75) Inventor: Wilhelmus Henricus Maria Van Cuijk, Uden (NL)

Correspondence Address: THE WEBB LAW FIRM, P.C., 700 KOPPERS BUILDING, 436 SEVENTH AVENUE, PITTSBURGH, PA, 15219, US

(73) Assignee: C. H. FOOD B. V., Uden (NL)

(21) Appl. No.: 10/534,649

(22) PCT Filed: Nov. 10, 2003
(86) PCT No.: PCT/NL03/00790

§ 371 Date: Jan. 6, 2006

(30) Foreign Application Priority Data
Nov. 18, 2002 (NL) 1021943

(51) Int. Cl. A23B 7/148

(52) U.S. Cl. 426/106

(57) ABSTRACT

The invention relates to a package for containing a plurality of products for heating, comprising: a container, manufactured from a material for once-only use, provided with at least two compartments shielded from the environment, and at least one passage opening arranged in the package for a medium for reducing an overpressure in the package, wherein the pressure in the compartments can be maintained at different levels. The invention further relates to a method for heating a plurality of products for heating placed in a single container to different temperatures using a heating source.

The invention relates to a package for containing a plurality of products for heating, in particular food products according the preamble claim 1. The invention also relates to a method for heating a plurality of products according the preamble of claim 12.

There has been a considerable increase in the use of meals which are simple to prepare. An example hereof is formed by the prepared meals which only need to be heated to be suitable for consumption. Such means are usually precooked and then cooled until shortly before the moment of use. Such meals are applied inter alinia for home use and for use in institutions, hospitals and schools. Heating of the cooled meal can take place in diverse ways, although the most usual is placing of the package in hot water or placing of the package in an oven. A drawback of these meals and the method of heating thereof is that all components making up the meal undergo the same heating. This detracts from the possibilities of preparing appetizing and healthy meals in this manner. Determined ingredients must for instance not become too hot in order to remain optimally vitamin-rich (for instance vegetables), other ingredients must not exceed a different specific temperature because this damages the texture or structure (for instance sauces), while conversely a third ingredient must exceed a specific temperature so as to be fully cooked or to kill bacteria (for instance meat or poultry). In addition, there may also be culinary reasons for desired temperature differences between different meal components.

U.S. Pat. No. 4,013,798 discloses a ventable package and a micro-wave shielding device for heating food, said package comprising a plurality of separated sealed compartments to be filled with food products. At least two, but less than all of said compartments defining ventable compartments. One portion of the seal being sufficiently weak as to rupture in response to build up of water vapor beyond a predetermined pressure level in a compartments whereby the water vapor may vent, through said ventable compartments and through the ruptured seal. For generating different temperatures in the different compartments a shielding box having apertures is provided. The shielding box is formed from a material which is opaque to microwave energy to selectively control the different degrees of exposure of food within the different compartments and thus to vary the temperatures of the food in different compartments while using a single microwave source in heating the package.

The object of the present invention is to provide a package and method with which a plurality of products brought together in a single container can be heated in simple manner with a single heating source, wherein the diverse products are heated to different temperatures resulting from different pressures in different separated compartments.

The invention provides for this purpose a package according claim 1. The temperature will stabilize at a determined value depending on the pressure applied to a product during the heating. Compare for instance the pressure cooker in which a relatively high pressure is realized, resulting in a higher cooking temperature, and a mountain climber who at high altitude already boils water at 80° C. By now connecting different passage openings (different pressure valves) to the different compartments, it will also be possible to realize different pressures (and therefore also temperatures) in the different compartments. This while the package still only need be heated with a single heating source, so that no complex operations are required for the heating. In addition to food at varying temperatures, non-food products can also be heated in this manner, optionally in combination with food produce (for instance a so-called hot towel). In a preferred embodiment the compartments are shielded from the environment by making use of a material layer, such as for instance a transparent plastic foil, so that a view of the products in the container can be provided with minimal use of material. The use of a shielding box according the prior art is superfluous and makes the present invention more efficient in use as both less material and less energy is required in heating the products. Furthermore the package according the invention can be heated with all different heat sources known for heating the products and not only in a micro wave oven as disclosed in the closest prior art.

In order to prevent undesirable exchange of gas between the environment and the interiors of the compartments, the passage openings are preferably blocked prior to use of the package, and open under the influence of pressure in the compartments. This guarantees a medium-tight closure of the compartments prior to use (heating) of the package. The result hereof is that perishable goods can be preserved for longer. Only when the operation of the passage openings becomes relevant are they opened (when a determined pressure is reached). Another option for ensuring closure of the passage openings before the start of heating can be realized in accordance with an embodiment variant in that the passage openings are blocked prior to use of the package, and open under the influence of a determined temperature being exceeded. This measure can also be applied in combination with opening of the passage openings under the influence of pressure, and this then results in increased certainty that the openings do not open prematurely (for instance in the case of uncontrolled pressure being applied to the package before heating begins).

The separate passage openings can be provided with underpressure valves acting at different pressure levels, and already know types of underpressure valve can for instance be applied for this purpose. It is also possible for the individual compartments to have passage openings with a total passage surface varying per compartment; these can bring about a determined pressure level in a compartment only when the passage surface is sufficiently small. One or more passage openings can connect as desired to a single compartment. It is thus possible for instance to make use in a package of only a single dimension for all passage openings, wherein the number of passage openings is varied per compartment.

In an embodiment variant of the package according to the present invention which is simple and inexpensive to manufacture, the passage openings are blocked prior to use of the package by means of a cover element (sticker) fixed with an adhesive layer, wherein the adhesive layer softens at a determined temperature. For a further increase in efficiency, such a cover element can also be used as information carrier relating to the content of the package, so that it serves a dual purpose. The cover element can moreover cover a plurality of passage openings as a single cover element, wherein weakened portions are then arranged in the cover element at the position of the passage openings, so that the cover element is released at the same moment at all positions where it covers a passage opening. It is noted that it is also possible to vary this measure; a conscious choice can be made to arrange a greater or lesser degree of weakening so as to further vary the moment at which the different passage openings open. As material for the cover element it is possible to choose from any conceivable material, such as for instance plastic or paper. In a particular variant use is made of a double foil layer, only one of the layers being provided with passage openings. Alternatively, the cover element can also be combined with the adhesive layer; an example hereof is an ink layer with which passage openings are closed.

It can be advantageous in practice for the passage openings to be arranged in the material layer (foil layer) with which the compartments are shielded from the environment. Such a foil layer is easy to provide with small openings and is generally situated on the top side of the package so that the product does not have to come into contact therewith (at least when the compartments are not fully filled), which, among other things, reduces the risk of leakage. Alternatively however, it is also possible for the passage openings to be arranged in the container.

In addition to the above described package, the invention also comprises an assembly of such a package and a plurality of products, in particular food products, placed in the individual compartments. By means of this assembly the advantages can be realized as described above with reference to the package according to the invention.

The invention also provides a method for heating to different temperatures a plurality of products according claim 12. The package can herein be heated with only a single hear source; not only in a microwave oven, but also in a hot air oven, a warm water bath or other known heat source for heating food products in particular. The package can for instance be readily placed in an oven which feeds heat to the container, where after, provided the package is heated for long enough at a prescribed temperature, the different products in the different compartments are heated to the intended distinct temperature levels without further intervention. After heating, the compartments can be made accessible for a meal by for instance detaching a material layer. It is particularly advantageous here if the material layer can be detached easily (also referred to as a peel-off attachment of the material layer). This reduces the danger, among others, of hot products leaving the container in uncontrolled manner. The heating according the invention is highly efficient in relation to the prior art as partially shielding the product to be heated does not occur.

The invention will be further elucidated with reference to the non-limitative exemplary embodiments shown in the following figures, in which:

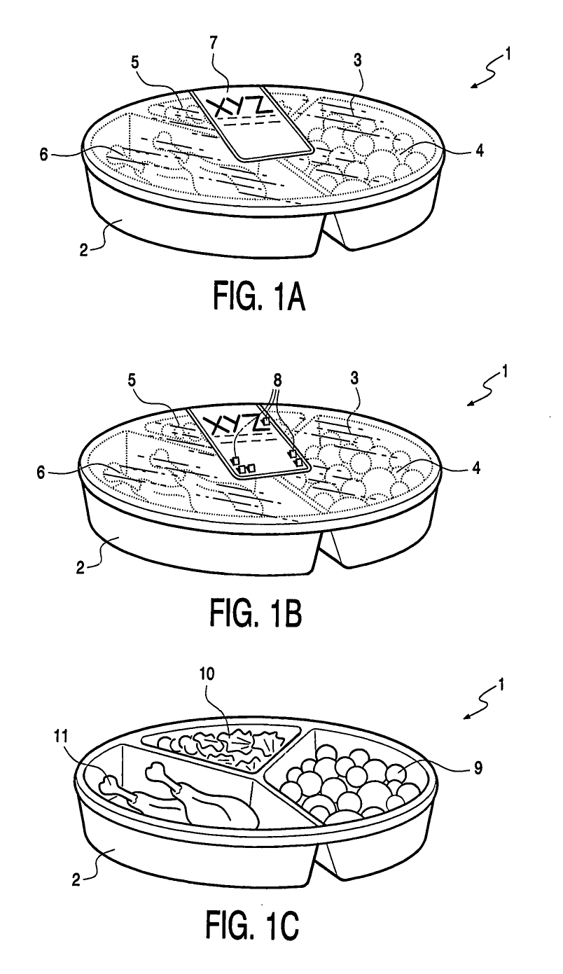

FIG. 1A shows a perspective view of a package according to the invention filled with food products before the start of heating,

FIG. 1B shows a perspective view of the package shown in FIG. 1A during heating,

FIG. 1C shows a perspective view of the package shown in FIGS. 1A and 1B after opening,

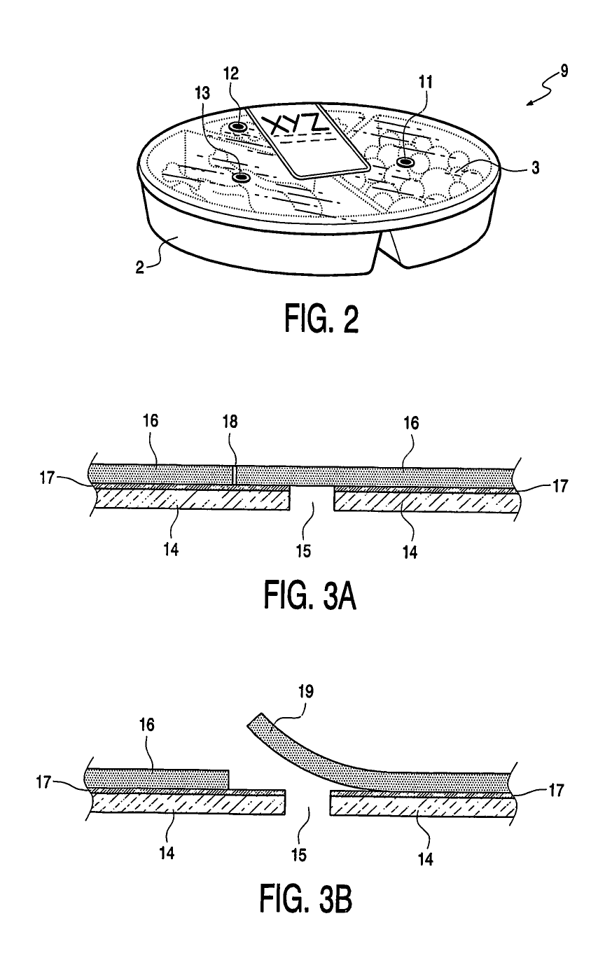

FIG. 2 is a perspective view of an alternative embodiment variant of the package according to the invention,

FIG. 3A shows a schematic cross-section through a closed passage opening,

FIG. 3B shows a schematic cross-section through the passage opening shown in FIG. 3A, now however in an opened position, and

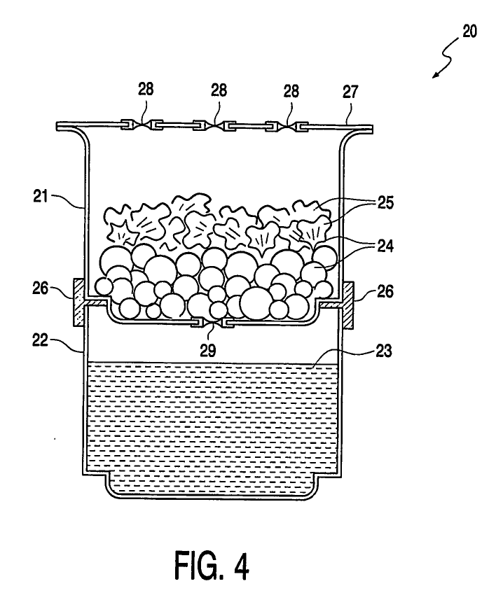

FIG. 4 shows a schematic cross-section through yet another embodiment variant of the package according to the invention.

FIG. 1A shows a package 1 provided with a container 2 which is covered with a transparent foil 3 such that package 1 comprises three compartments 4, 5, 6 separated medium-tightly from each other and the environment. A sticker 7 containing product information is placed on foil 3. Package 1 is adapted particularly to contain food, and is generally kept refrigerated prior to use.

During heating of package 1, which is shown in FIG. 1B, the adhesive layer with which sticker 7 is adhered to foil 3 will soften (see also description relating to FIG. 3B). As a consequence partially released portions 8 of sticker 7 will be pressed upward by medium pressure exerted from compartments 4, 5, 6 on the partially released portions 8 by means of openings (not shown) arranged specially for this purpose in foil 3. The openings in foil 3 are relatively small, and the number of openings in foil 3 can be varied at the position of the different compartments 4, 5, 6. It can be seen in the figure that two pressed-upward, released portions 8 connect onto compartment 4, one pressed-upward, released portion 8 connects onto compartment 5 and three pressed-upward, released portions 8 connect onto compartment 6. The pressure in compartments 4, 5, 6 will thus be able to vary. Once package 1 has been heated for a sufficiently long time, foil 3 can be pulled loose and food 10 in container 2 is accessible for consumption, see here for FIG. 1C.

FIG. 2 shows a package 9 with a container 2, wherein more conventional valves 11, 12, 13 are placed in foil 3 which function at mutually differing pressures. The pressure in the individual compartments 4, 5, 6 can thus also be maximized at mutually differing values.

FIG. 3A shows a schematic section through a foil 14 in which an opening 15 is arranged. A sticker 16 is adhered to foil 14 using an adhesive layer 17 such that sticker 16 closes the opening 15 in foil 14. A cut 18 is further made in foil 14. The situation shown in his figure corresponds to a situation of a passage opening in package 1 of FIG. 1A prior to heating of package 1. When package 1 is now heated the situation as shown in FIG. 3B will result. By means of pressure exerted on sticker 16 through opening 15 in foil 14, in combination with softening of adhesive layer 17 at a determined temperature and the cut 18, a sticker portion 19 will be pressed away from foil 14. The consequence hereof is that the opening 15 in the foil is left clear and will function as passage opening for medium (gases, steam and so on).

Finally, FIG. 4 shows yet another package 20, now however with two stacked compartments 21, 22. The lower compartment contains for instance soup 23, while the upper compartment 22 contains for instance soup balls 24 and soup vegetables 25. The upper compartment closes the lower compartment 21 and compartments 21, 22 are coupled to each other by a connecting element 26 to prevent undesired release of compartments 21, 22 from each other. The upper compartment 22 is closed with a foil 27 in which three passage openings 28 are placed, while a passage opening 29 is also provided in the bottom of the upper compartment 22. Package 20 is now dimensioned such that the pressure level in upper compartment 22 is maximized at a lower level than the pressure level in lower compartment 21. It will hereby be possible to heat soup 23 to a higher temperature than soup balls 25 and soup vegetables 25, which moreover also undergo a kind of steam treatment.

1-15. (canceled)

16: A package for containing a plurality of products for heating, in particular food products, comprising:
a container, manufactured from a material for once-only use, provided with at least two compartments shielded from the environment wherein the compartments are separated medium-tightly from each other, and
the individual compartments are provided with passage openings for a medium for reducing overpressure in the package, wherein the passage openings of the individual compartments differ from each other such that overpressure in individual compartments is maximized at different pressure levels.

17: The package as claimed in claim 16, wherein the compartments are shielded from the environment by making use of a material layer.

18: The package as claimed in claim 16, wherein the passage openings are blocked prior to use of the package, and open under the influence of pressure in the compartments.

19: The package as claimed in claim 16, wherein the passage openings are blocked prior to use of the package, and open under the influence of a determined temperature being exceeded.

20: The package as claimed in claim 16, wherein the separate passage openings are provided with pressure valves acting at different pressure levels.

21: The package as claimed in claim 16, wherein the individual compartments have passage openings with a total passage surface varying per compartment.

22: The package as claimed in claim 16, wherein the passage openings are blocked prior to use of the package by means of a cover element fixed with an adhesive layer, wherein the adhesive layer softens at a determined temperature.

23: The package as claimed in claim 22, wherein a single cover element covers a plurality of passage openings and that weakened portions are arranged in the cover element at the position of the passage openings.

24: The package as claimed in claim 16, wherein the passage openings are arranged in the material layer with which the compartments are shielded from the environment.

25: The package as claimed in claim 16, wherein the passage openings are arranged in the container.

26: An assembly of a package as claimed in claim 16 and a plurality of products, in particular food products, placed in the individual compartments.

27: A method for heating to different temperatures with a heating source a plurality of products for heating, in particular food products, placed in a single container, by heating with a heating source the container with a plurality of separated compartments provided with the products for heating, wherein an overpressure is created in the compartments which is bounded by passage openings connecting onto the individual compartments,
wherein different passage openings of the individual compartments maximize the pressure in different compartments at different pressures thus occurring different temperatures in the compartments.

28: The method as claimed in claim 27, wherein the container is heated with a single heating source.

29: The method as claimed in claim 27, wherein the container is placed in an oven.

30: The method as claimed in claim 27, wherein after heating the compartments are made accessible for a meal by detaching a material layer.
